(19) United States
(12) Patent Application Publication
(10) Pub. No.: US 2020/0193383 A1
(43) Pub. Date: Jun. 18, 2020

(54) EMPLOYMENT MANAGEMENT SYSTEM

(71) Applicants: Elias Philipou, Brisbane, Queensland (CY); Bossii LTD (Cyprus), Nicosia (CY)

(72) Inventor: Elias Philipou, Brisbane, Queensland (AU)

(21) Appl. No.: 16/638,901

(22) PCT Filed: Aug. 14, 2018
(86) PCT No.: PCT/AU2018/050857

§ 371 Date: Feb. 13, 2020

(30) Foreign Application Priority Data
Aug. 15, 2017 (AU) 2017903263

(51) Int. Cl. G06Q 10/10; G06Q 10/06

(52) U.S. Cl. CPC G06Q 10/1053; G06Q 10/109; G06Q 10/063112; G06Q 10/06398

(57) ABSTRACT

An employment management system, for managing employment across a plurality of employers and a plurality of employees, the employment management system including a feedback module, configured to receive feedback relating to the employees from their respective employers and a recruitment module, configured to enable a first employer of the plurality of employers to employ an employee based upon feedback of that employee from a second employer.

### TECHNICAL FIELD

The present invention relates to employment management systems. In particular, although not exclusively, the present invention relates to retail and hospitality employment management systems.

### BACKGROUND ART

While the retail and hospitality industries have long been a big employer of workers, it has long been difficult to manage workplaces in these industries. In particular, there are many different systems, from point of sale, to rostering, to recruiting systems, which must all be integrated manually, typically by a manager.

Furthermore, employment turnover is generally high in the retail and hospitality industries, which places a further burden on the management systems mentioned above. It is generally difficult to recruit and retain good employees because of traditionally inefficient and costly practices.

A further problem in the retail and hospitality industries is underemployment. Many people in these industries work only 20-30 hours a week, or less, meaning that while they are technically employed, they have an underutilised capacity.

Finally, when moving between employers in the retail and hospitality industries, it is difficult to verify an employees work history and suitability. Contacting referees of potential employees is time consuming, and may not be accurate, as an employee will generally only include favourable referees on a resume.

As such, there is clearly a need for an improved employment management system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to employment management systems, which may at least partially overcome at least one of the abovementioned disadvantages or provide the consumer with a useful or commercial choice.

With the foregoing in view, the present invention in one form, resides broadly in an employment management system, for managing employment across a plurality of employers and a plurality of employees, the employment management system including:

a feedback module, configured to receive feedback relating to the employees from their respective employers; and

a recruitment module, configured to enable a first employer of the plurality of employers to employ an employee based upon feedback of that employee from a second employer.

Advantageously, recruitment time is significantly reduced as the first employer is able to quickly and easily get accurate feedback data relating to the employees.

Preferably, the feedback is provided periodically. Suitably, the feedback is provided for each shift. The feedback module may be configured to automatically prompt a manager to rate the employees as each shift concludes. Suitably, feedback may be provided at a rate chosen by the employers.

Preferably, a rating is generated for each of the employees based upon the feedback. In some embodiments, more than one rating is generated. The ratings may relate at least to skill and attitude.

Preferably, the feedback module is configured to enable the employees to rate the employers.

Preferably, the system is configured to receive availability information from the plurality of employees, wherein the recruitment module enables the first employer to employ the employee at least in part based upon the availability information.

Preferably, the recruitment module is configured to receive one or more criteria from the first employer, select a set of potential employees of the plurality of employees based upon the one or more criteria, and provide the set of potential employees to the employer for consideration. Such set of potential employees may be called the “long list”.

The recruitment module may be configured to sort the set of employees based upon an associated rating.

The system may be configured to enable the employer to view employee profiles and/or ratings of the employees on the long list. The system may be configured to enable employees on the long list to view an associated employer profiles and/or rating.

The recruitment module may be configured to enable the employer to select a “short list” from the set of employees. Each of the employees in the short list may be automatically notified of the available position. Each of the employees in the short list may be provided with rating data of the employer.

Preferably, the system further includes a time and attendance module, configured to monitor an attendance of the employees. Preferably, the time and attendance module is configured to enable the employees to clock in and out. Preferably, the time and attendance modules is configured to enable employees to manage breaks in and out. Preferably, time and attendance data of the time and attendance module is reviewed and approved by the employer.

The time and attendance module may be configured to verify a geo-location of the employee. The geo-location may be verified using one or more location features of the associated employee device.

Preferably, the system further includes a payroll module, configured to generate payroll data based upon attendance data of the attendance module. Preferably, the payroll module is configured to supply payroll data to an accounting package.

Preferably, the system further includes a rostering module, configured to enable the employers to generate rosters. Preferably, the attendance module enables employees to check in and out based upon rostering data of the rostering module.

Preferably, the rostering module is configured to enable the employers to generate rosters in part based upon past rosters. The rostering module may be configured to generate rosters in part based upon historical data and/or employee availability.

Preferably, the system further includes an on-boarding module, for the procurement of employee information. The employee information may be used to generate a profile of the employee, the profile including financial information, such as tax file number, bank details and superannuation details.

The on-boarding module may be configured to receive a profile from each of the employees. The profile of the employees may be used by multiple employers, thus alleviating the need for an employee to enter the same data multiple times.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates retail and hospitality employment management system, according to an embodiment of the present invention;

FIG. 2 illustrates an exemplary use case of the retail and hospitality employment management system of FIG. 1, according to an embodiment of the present invention; and

FIG. 3 illustrates a schematic of a server of the system of FIG. 1, identifying the different modules thereof, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

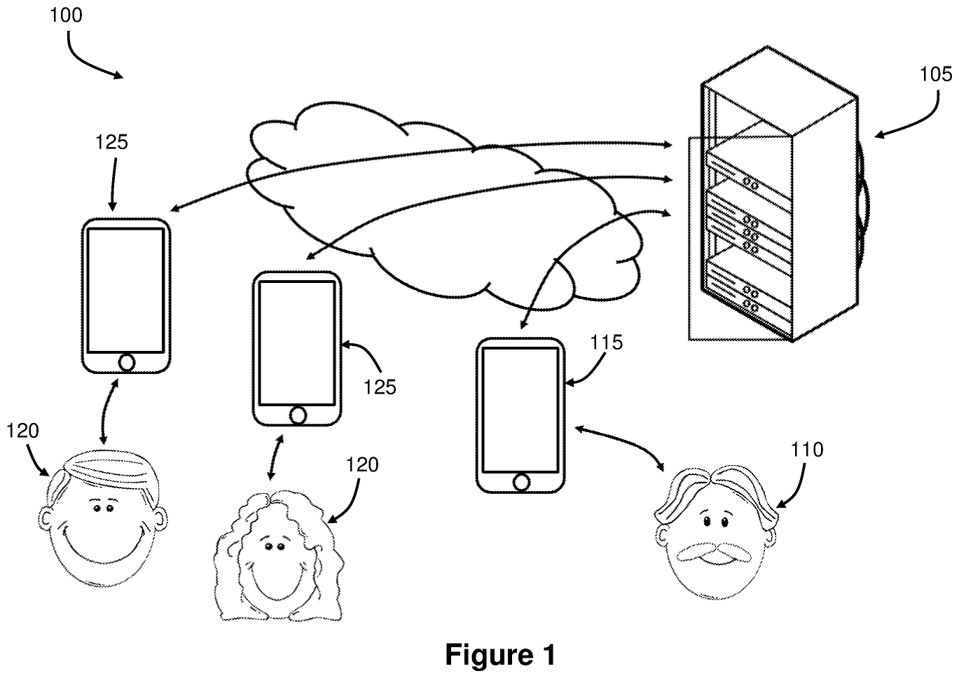

FIG. 1 illustrates a retail and hospitality employment management system 100, according to an embodiment of the present invention. The system 100 enables the recruitment of potential employees based on feedback from their current or past employers, which is more accurate and efficient, thus enabling vacancies to be filled very quickly. Furthermore, when a new employee is added, the on-boarding process of the employee is greatly simplified, as is employment management generally, including time and attendance information.

Embodiments of the invention may be used by industry associations to increase membership and to improve membership retention, as outlined in further detail below.

The system 100 includes a central server 105, with which an employer 110 may interact using an employer device 115. The employer device 115 may comprise a smartphone or similar device with an application thereon to enable communication with the server 105.

The central server 105 includes a variety of functions including recruitment, on boarding, rostering, time and attendance, evaluation and feedback, and payroll management functions, as outlined below. In particular, the central server 105 is configured to enable the employer 110, through interaction with the employer device 115, to manage the entire human resource (HR) side of a business from recruitment of employees 120, as well as automatically on boarding, rostering, managing attendance, evaluating and managing payroll of the employees 120.

Each employee 120 also interacts with the central server 105 through respective employee devices 125, which again may comprise smartphones of similar devices with an application thereon. The employee devices 125 may be provided to the employees 120 for work purposes, or be private devices adapted to function in such manner.

When working a shift, each employee 120 initially checks in to the shift by interacting with the employee devices 125, and checks out at the end of the shift, by again interacting with the employee devices 125. The employee devices 125 upload such information to the server 105, which forms the basis for a time and attendance record.

The employee devices 125 may be configured to verify a location of the employee 120, e.g. using global positioning systems (GPS) data, or by any other suitable means. Similarly, the employee devices may be configured to enable the employees 120 to record breaks, or any other gaps in attendance.

The server 105 collates this time and attendance data, and uses same to generate payroll information, which may be exported from the server 105 to an accounting package. The server 105 may enable the employer 110 to approve the payroll information prior to export to the accounting package.

In addition to approving time and attendance information and/or payroll information, the employers 110 rate each employee 120 at the end of the employees shift. The server 105 may be configured to automatically prompt the employer 110 to rate the employees 120 as each shift concludes, so that entry of the rating information is not delayed.

In addition to checking out at the end of each shift, the employees are also able to rate their manager and/or employer. As such, two way ratings are provided between the employees and employers, which provides accountability in both directions.

In particular, and as outlined in further detail below, as the employees are rated for their job duties, potential other employers are able to quickly and easily identify high performing employees as candidates for further work. The ratings are advantageously updated in real time as the employees 120 are rated for work performed, and the ratings may relate to specific tasks, attitude, or any suitable factor.

Furthermore, as employees 120 rate their employer and/or manager 110, other potential employees 120 are able to assess whether they wish to work for this employer/manager 110 or not, by quickly reviewing review information.

While FIG. 1 illustrates a single workspace (i.e. one employer/manager 110 and two employees 120), several advantages of the invention are particularly evident when the system 100 is used over a wide ranges of workplaces, i.e. with many employees 120 and employers/managers 110. One particularly embodiment of the invention is suited to be deployed by an Industry Association (IA).

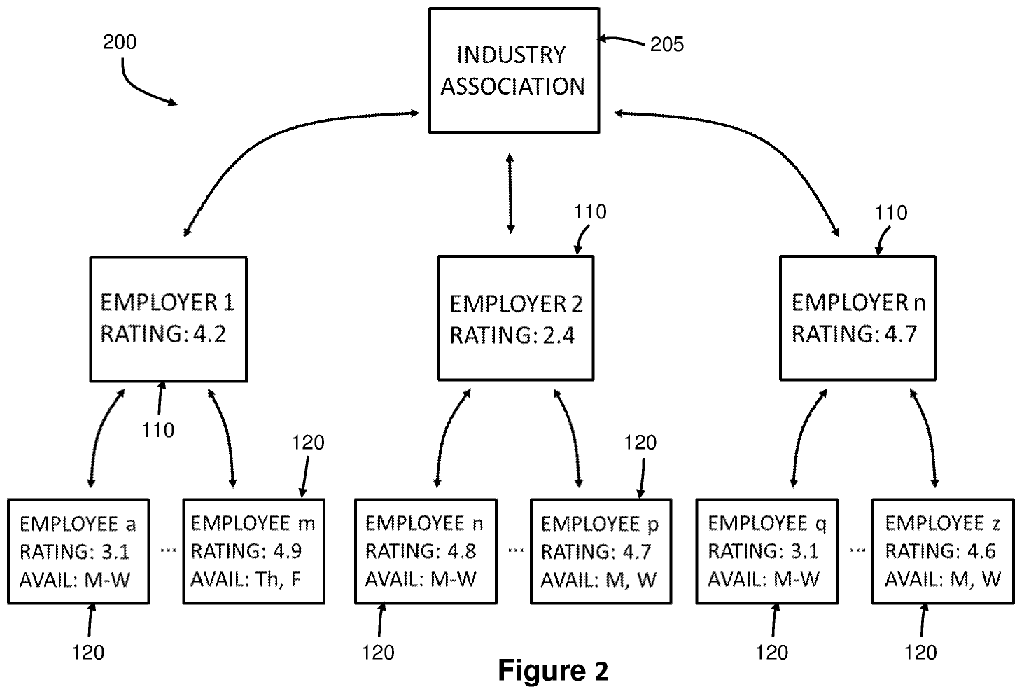

FIG. 2 illustrates an exemplary use case 200 of the retail and hospitality employment management system 100, according to an embodiment of the present invention. The use case 200 is industry association specific, but may be easily adapted to suit multiple industry associations, or any suitable group of employers.

Initially, an Industry Association (IA) 205 contacts its industry participants (i.e. employers 110) with an offer to enrol with the system 100. In particular, an invite is sent by the IA 205 to a primary contact person associated with each of the employers 110. This may be by text messaging (SMS), email or by any other suitable means.

The manager, employer and primary contact person are illustrated as a single person (i.e. the employer 110) in this scenario for the sake of simplicity. The skilled addressee will, however, readily appreciate that several persons may take on these roles, and that an employer 110 may have several managers, and that a separate contact person may be associated with the IA 205.

The invitation includes a download link, which enables the employer 110 to be able to download an application onto the employer device 115, to enable the employer 110 to communicate with the server 105. The employer 110 then reviews and accepts terms and conditions associated with the system 100, and enters his or her personal details, together with details of the business.

The employer 110 then, through interaction with the server 105, sends invites out to its own employees 120 via SMS or Email, in a similar manner to that outlined above, to allow the employees 120 to also download an application to their respective employee devices 125.

When a new employee 120 starts, he or she is also invited to download the application into his or her employee device 125, at which time on-boarding takes place. On-boarding only takes place once, and the employee's details are saved even in case the employee 120 moves to another employer within the system 100.

When entering his or her personal details, the employee 120 may also enter his or her additional work availability. This is particularly useful in case the employee 120 is employed part time, and wishes to supplement his or her employment by working on the days he or she is available. This data may be updated periodically, or as the employee's situation changes.

As work is performed, feedback relating to the employees from their respective employers is provided, as well as feedback of the employers from the employees. Rating data is then generated based upon the feedback and saved on the server 105.

When the employers 110 need further staff, a request can be made to the system 100 using the employer device 115. In the request, the employer 110 can input a plurality of criteria, such as when the person is required to work (e.g. Monday to Wednesday), what skills the person requires (e.g. Barista), a minimum required skills rating in that area (4.5/5), a minimum attitude rating (4/5), and/or a within a particular distance of a workplace (<10 km).

The server 105 then generates a “long list” of potential employees 120 that fit the criteria. The list is advantageously sorted according to one or more ratings, to enable the employer to quickly get an overview of the potential employees.

From the initial “long list” of potential employees, the employer can review private profiles of the potential employees, and create a “short list” of employees based thereon. When an employee is selected as part of a short list, he or she is sent confirmation of same, and is able to review details of the employer, including a rating of the employer from the employees of the employer. The employee may then choose to accept or decline the offer, and the first employee to respond positively will receive an employment offer.

In the scenario 200 of FIG. 2, the first employer 110 (Employer 1) may require an additional employee that is available Saturdays. In such case, the server 105 is able to determine that employees “n”, “q” and “z” are available Saturdays, and returns same as an ordered list. As employee n has the highest rating (4.8), he or she is presented first, followed by employee z (4.6) and employee q (3.1). Employee p is not provided in the list, despite a relative high rating, due to his or her unavailability on Saturday (Employee p is only available Monday (M) and Wednesday (W).

The employer may shortlist one or more of employees n, z and q, upon which the shortlisted employees are notified. The shortlisted employees may then review the employer, who has a rating of 4.2, and choose whether or not to accept or decline the offer.

According to certain embodiments, high rating employers are provided access to high rating employees. As such, employers are rewarded with high employee ratings, and high performing employees are not bombarded with job offers from low performing employers.

As such, the scenario 200 enables an employee to have multiple employers, and in particular employers that complement the employee's personal circumstances. Furthermore, the system 100 enables the employment pool of individuals to be increased, as those looking for additional work are automatically considered when schedules are compatible.

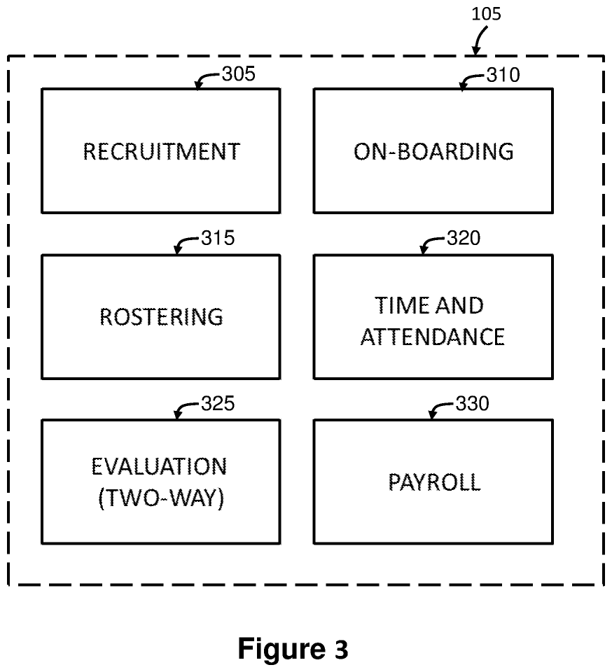

As outlined above, the employer 110 is able to perform a full range of employment management activities using the system 100, including human resource activities, which are provided by the server 105. FIG. 3 illustrates a schematic 300 of the server 105, identifying the different modules.

The server 105 includes a recruitment module 305, which enables the employer 110 to recruit new employees, based upon their requirements, as outlined above. As the system enables access to employees within an entire industry (e.g. through the IA 205), employers are able to gain access to new employees in a matter of seconds rather than days or weeks as is the case with prior systems.

In some embodiments, multiple industry associations may use the system 100, and in such case employers may be able to access employees from multiple industry associations that have the job skills required.

The server 105 includes an on-boarding module 310, which enables the procurement of employee information enabling simple and automatic access to employee personnel records by the employer.

In particular, the employee generates a profile which may include information such as employee name and nickname, a profile picture, and address, a date of birth, employee contact details including phone and email, personal bio documents including awards received, a historical resume, RSA and RMLV documents (where appropriate), personal financial details including banking details, superannuation account details and a government tax file number (TFN), photos and/or videos illustrating the employees skills, travel preferences (e.g. possible travel distance for future employment opportunities), available work times or hours, job positions sought and a personal evaluation for nominated job positions, historical employment details, and interests/activities/qualifications.

Once the profile is generated, the employee may select a passcode or password to enable access control and to ensure the privacy of personal information entered.

When a new employer enrols into the system 100, a similar process is followed. In particular, the employer creates a business profile, which may include information such as business name, ABN and/or ACN, business type, address, contact details including website, email, phone, and social media pages (e.g. Instagram, Twitter and Facebook), work location, details of an accounting package used, where WIFI is available at the workplace, business documents including employer policies and procedures, photos or videos of the workplace (venue), any employee Pay Award Agreement or Enterprise Agreement including options to switch off particular aspects of award if required (which may be logged for auditability purposes), job position descriptions, opening hours and days, and organisational structure.

On-boarding needs to be performed only once, but can be updated when details change (e.g. when an employee changes address).

The server 105 includes a rostering module 315, which enables the employer 110 to manage employee shift times. Rosters may be created for any time interval, including weekly rosters, monthly rosters, or the like.

A roster may be created in the rostering module 315 from scratch, or by duplicating an earlier roster (e.g. the previous weeks roster), and making edits thereto (if appropriate).

The rostering module 315 may include one or more templates, which the employer 110 can download. The employer 110 may generate templates him or herself for later retrieval.

According to certain embodiments, the rostering module determines a staff need based upon sales, and at least partly generates the roster based thereon. In this regard, the roster may be generated based on historical turnover data, and any associated history of the employee's job duties required at the time of making that turnover.

Employees are able to connect to the rostering module 315, and indicate their availability. The rostering module may then allow only rostering of staff when they are available.

Once the roster is created, it is published to the relevant employees using notifications to the employee devices. Employees are able to lodge “Shift Swap” requests, which will enable the employee to swap his or her shift with another employee should their availability change.

The roster module may be coupled to third party calendar services, and each employee may configure their roster to populate into a calendar service of their choice.

The server 105 includes a time and attendance module 320, which enables the employer 110 to manage actual shift times of the employees.

Where rosters relate to a budgeted expectation of the times that employees should work, the time and attendance module 320 documents and manages the actual times that employees start their shift, start and finish breaks, and finish their shift.

In particular, each employee may open the mobile application associated with their workplace, and tap a “Start Shift” button. This may require the user to enter a passcode, to prevent fraudulent activity.

The mobile application together with time and attendance module 320 may include one or more security or verification features including scanning the employees fingerprint, capturing an image of the employee at their workplace, recognising (e.g. using GPS) that the employee is at work, through interaction with a venue located device, or via the employers own personal mobile device.

Employees are also able to go on a break, come back off their break and clock off their shift in similar methods as above.

When clocking off, the system is configured to show the employee how much money has been made in the shift, and how much money has been made in the current pay period.

The employer is also able to manage, view and account for the employees and the associated costs from their own mobile device.

The server 105 includes an evaluation and feedback module 325, which enables the employees on a shift to be rated, and the business/employer to be rated by the employees, as outlined above. The evaluation and feedback module 325 may be configured to provide a set of mandatory rating questions to the employees and employers, after each interaction is finalised (e.g. at the end of a shift).

The employer may be prompted with multiple questions regarding each employee, such as “What was the Employees Attitude like today?” and “What were the Employees skills like today?” Similarly, the employee may be prompted with multiple questions, such as “What difference did you feel like you made at XYZ today?”, and “How professional did you feel like XYZ was today?”

Both the employers and the employees may be able to submit further feedback, if desired.

Star ratings are then generated for the employers and employees based upon the responses. The star rating may be out of five, and be generated by averaging the ratings. In some embodiments the responses are filtered prior to generating the star rating. This may be to remove extreme responses (outliers).

When the star ratings are provided (e.g. to potential employees), they may be shown together with the number of responses which are used to generate the rating. This enables the user viewing the rating to place a value on the rating, which may be very different if it is calculated based upon 8 responses, for example, where the value may be low, or 2895 responses, for example, where the value may be high.

Finally, the server 105 includes a payroll management module 330. The payroll management module enables management of payroll, including penalty rates, together with a third party accounting package.

The employer 110 is periodically provided a list of employee wages for approval, which are upon approval sent to an accounting package, from which the funds are transferred to the employees' bank accounts.

Once payment is made by the employer, payroll advice is immediately sent to the employee to their mobile device. If they believe that something is incorrect with their hours or pay rate, they can tag the item in question direct from their payroll advice and send a payslip query to the employer 110.

According to certain embodiments (not illustrated), the system 100 includes point of sale functionality. In particular, the employer and employee devices 115, 125 are able to be used to take orders and receive payment. In some particular embodiments, customers may be able to download an application that interfaces with the server 105, to enable the customer to place and order and make payment directly.

While the above systems 100 are described in their current state (e.g. current employees and current employers), review data from past employees and employers is generally used to generate scores and associated data. In some embodiments, older data may be given less weight than more recent data.

The embodiments described above have several benefits over prior art systems. For example, the recruitment of potential employees based on feedback from their current or past employers is more accurate and efficient, enabling vacancies to be filled very quickly. Furthermore, when a new employee is added, the on-boarding process of the employee is greatly simplified. Furthermore, time and attendance is more easily managed and verified, and as a result, is more accurate.

Embodiments of the invention may be used by industry associations to increase membership and to improve membership retention. In particular, the system 100 may be provided to members, and enable the members to share staff.

Data from the system may be provided to the industry association, to provide real time industry statistics to be captured. Such data may then be provided back to the members, or others.

For employers, costs to recruit new staff are greatly reduced, and the pool of staff available is increased, resulting in better quality employees.

Furthermore, the employee rating and feedback system enables employers to identify key staff (or problem staff) and take appropriate action.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1.-19. (canceled)

20. An employment management system, for managing employment across a plurality of employers and a plurality of employees, the employment management system including a feedback module, configured to receive feedback relating to the employees from their respective employers and a recruitment module, configured to enable a first employer of the plurality of employers to employ an employee based upon feedback of that employee from a second employer.

21. The employment management system of claim 20, wherein the feedback module is configured to automatically prompt a manager to rate the employees as each shift concludes.

22. The employment management system of claim 20, wherein the feedback module generates a numerical rating for each of the employees based upon the feedback.

23. The employment management system of claim 20, wherein the feedback module is configured to enable the employees to rate the employers.

24. The employment management system of claim 20, wherein the system is configured to receive availability information from the plurality of employees, wherein the recruitment module enables the first employer to employ the employee at least in part based upon the availability information.

25. The employment management system of claim 20, wherein the recruitment module is configured to receive one or more criteria from the first employer, select a set of potential employees of the plurality of employees based upon the one or more criteria, and provide a results list including the set of potential employees to the employer for consideration.

26. The employment management system of claim 25, wherein the recruitment module is configured to sort the set of employees based upon an associated rating.

27. The employment management system of claim 25, wherein the system is configured to enable the employer to view employee profiles and/or ratings of the employees on the results list.

28. The employment management system of claim 25, wherein the system is configured to enable employees on the results list to view an associated employer profiles and/or rating.

29. The employment management system of claim 25, wherein the recruitment module is configured to enable the employer to select a short list from the set of employees.

30. The employment management system of claim 29, wherein each of the employees in the short list is automatically notified of the available position.

31. The employment management system of claim 29, wherein each of the employees in the short list is provided with rating data of the employer.

32. The employment management system of claim 20, wherein the system further includes a time and attendance module, configured to monitor an attendance of the employees.

33. The employment management system of claim 32, wherein the time and attendance module is configured to verify a geo-location of the employee using one or more location features of an employee personal computing device carried by each employee.

34. The employment management system of claim 32, wherein the system further includes a payroll module, configured to generate payroll data based upon attendance data of the time and attendance module.

35. The employment management system of claim 20, wherein the system further includes a rostering module, configured to enable the employers to generate rosters.

36. The employment management system of claim 32, wherein the rostering module is configured to enable the employers to generate rosters in part based upon past rosters.

37. The employment management system of claim 20, wherein the system further includes an on-boarding module, for the procurement of employee information used to generate a profile of the employee, the profile including financial information, including at least tax file number, bank details and superannuation details.

38. The employment management system of claim 37, wherein the on-boarding module is configured to receive a profile from each of the employees which can be used by multiple employers within the system.
